(19) United States
(12) Patent Application Publication
(10) Pub. No.: US 2023/0232264 A1
(43) Pub. Date: Jul. 20, 2023

(54) MULTI-PORT CONFIGURATION IN CROSS-LINK INTERFERENCE (CLI) MEASUREMENT

(71) Applicant: QUALCOMM Incorporated, San Diego, CA (US)

(72) Inventors: Yuwei Ren, Beijing (CN); Huilin Xu, Temecula, CA (US); Sony Akkarakaran, Poway, CA (US)

(21) Appl. No.: 17/996,477

(22) PCT Filed: Apr. 30, 2020
(86) PCT No.: PCT/CN2020/088063

§ 371 Date: Oct. 18, 2022

(51) Int. Cl. H04W 24/10; H04B 17/336; H04L 5/00

(52) U.S. Cl. CPC H04W 24/10; H04B 17/336; H04L 5/0051

(57) ABSTRACT

This disclosure provides systems, methods, and apparatuses, including computer programs encoded on computer storage media, for wireless communication. In one aspect of the disclosure, a method of wireless communication performed by a user equipment (UE) includes performing one or more cross-link interference (CLI) measurements on each of multiple ports to determine a plurality of measurement values for the multiple ports. The method also includes transmitting a CLI measurement report based on the plurality of measurement values.

### TECHNICAL FIELD

Aspects of the present disclosure relate generally to wireless communication systems, and more particularly, to cross-link interference (CLI) measurement.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the applications for wireless communication proliferate and there are greater numbers and densities of wireless communication devices within coverage areas, managing interference among the devices may become more challenging. In some example scenarios, one UE, referred to as a “victim UE,” may be receiving a downlink (DL) communication from a base station as another UE, referred to as an “aggressor UE,” is transmitting an uplink (UL) communication, which interferes with the DL communication. As a result, an UL symbol transmitted by the aggressor UE may collide with a DL symbol received by the victim UE. Such interference between the DL and UL may be referred to as cross-link interference (CLI). The victim UE may be configured to perform CLI measurements to measure the CLI based on a CLI resource configuration received from the base station. Typically, the base station configures a single CLI resource for use by the victim UE to perform each CLI measurement, and each CLI measurement may be performed periodically and may trigger an event or a periodic report of the CLI measurement result. For example, the event may be the presence of an amount of CLI at the victim UE that exceeds a threshold. However, a single CLI resource may not be detected or trigger the event.

Additionally, at least some types of CLI resources of a victim UE are configured with a single port, which further increases the likelihood that the event is not triggered. For example, a network may configure an aggressor UE with multiple ports for sounding reference signals (SRS) and configure the victim UE with a single SRS resource, such as a single SRS port that corresponds to a port of the multiple ports for SRS transmission from the aggressor UE, to measure CLI. In some implementations, if the victim UE is configured to receive SRS for CLI measurement, the victim UE SRS configuration for CLI measurement is independent of the SRS configuration of the aggressor UE for transmission. When each port of the aggressor UE’s SRS is separately configured, radio resource control (RRC) CLI configuration overhead can be increased and the victim UE may separately demodulate SRS resources for all ports of aggressor UE’s SRS as victim UE does not know these resources are associated with the same aggressor UE.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method of wireless communication performed by a user equipment (UE). The method includes performing one or more cross-link interference (CLI) measurements on each of multiple ports to determine a plurality of measurement values for the multiple ports. The method further includes transmitting a CLI measurement report based on the plurality of measurement values.

Another innovative aspect of the subject matter described in this disclosure can be implemented in a UE. The UE includes at least one processor and a memory coupled with the at least one processor and storing processor-readable instructions that, when executed by the at least one processor, is configured to perform one or more cross-link interference (CLI) measurements on each of multiple ports to determine a plurality of measurement values for the multiple ports. The at least one processor is further configured to initiate transmission of a CLI measurement report based on the plurality of measurement values.

Another innovative aspect of the subject matter described in this disclosure can be implemented in an apparatus configured for wireless communication. The apparatus includes means for performing one or more cross-link interference (CLI) measurements on each of multiple ports to determine a plurality of measurement values for the multiple ports. The apparatus also includes means for transmitting a CLI measurement report based on the plurality of measurement values.

Another innovative aspect of the subject matter described in this disclosure can be implemented in a non-transitory computer-readable medium storing instructions that, when executed by a processor, cause the processor to perform operations including performing one or more cross-link interference (CLI) measurements on each of multiple ports to determine a plurality of measurement values for the multiple ports. The operations also include transmitting a CLI measurement report based on the plurality of measurement values.

Another innovative aspect of the subject matter described in this disclosure can be implemented in a method of wireless communication performed by a base station. The method includes transmitting, to a user equipment (UE), a message including a cross-link interference (CLI) resource configuration indicating multiple ports for a plurality of CLI measurements. The method further includes receiving, from the UE, a CLI measurement report based on the plurality of CLI measurements by the UE via the multiple ports.

Another innovative aspect of the subject matter described in this disclosure can be implemented in a base station. The base station includes at least one processor and a memory coupled with the at least one processor and storing processor-readable code that, when executed by the processor, is configured to initiate transmission, to a user equipment (UE), a message including a cross-link interference (CLI) resource configuration indicating multiple ports for a plurality of CLI measurements. The at least one processor is further configured to receive, from the UE, a CLI measurement report based on the plurality of CLI measurements by the UE via the multiple ports.

Another innovative aspect of the subject matter described in this disclosure can be implemented in an apparatus configured for wireless communication. The apparatus includes means for transmitting, to a user equipment (UE), a message including a cross-link interference (CLI) resource configuration indicating multiple ports for a plurality of CLI measurements. The apparatus further includes means for receiving, from the UE, a CLI measurement report based on the plurality of CLI measurements by the UE via the multiple ports.

Another innovative aspect of the subject matter described in this disclosure can be implemented in a non-transitory computer-readable medium storing instructions that, when executed by a processor, cause the processor to perform operations including initiating transmission, to a user equipment (UE), a message including a cross-link interference (CLI) resource configuration indicating multiple ports for a plurality of CLI measurements. The operations further include receiving, from the UE, a CLI measurement report based on the plurality of CLI measurements by the UE via the multiple ports.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system.

FIG. 2 is a block diagram conceptually illustrating an example design of a base station and a user equipment (UE).

FIG. 3 is a diagram illustrating examples related to cross-link interference (CLI).

FIG. 4 is a block diagram illustrating an example wireless communication system that supports performing CLI measurements on multiple CLI resources according to some aspects.

FIG. 5 is a diagram illustrating examples of CLI measurements on multiple CLI resources according to some aspects.

FIG. 6 is a diagram illustrating examples of CLI measurement patterns according to some aspects.

FIG. 7 is a diagram illustrating an example of CLI measurements on multiple CLI resources according to some aspects.

FIG. 8 is a flow diagram illustrating an example process that supports performing CLI measurements on multiple CLI resources according to some aspects.

FIG. 9 is a block diagram of an example UE that supports performing CLI measurements on multiple CLI resources according to some aspects.

FIG. 10 is a flow diagram illustrating an example process that supports configuring CLI resources to enable CLI measurements on multiple CLI resources according to some aspects.

FIG. 11 is a block diagram of an example base station that supports configuring CLI resources according to some aspects.

Like reference numbers and designations in the various drawings indicate like elements.

The Appendix provides further details regarding various embodiments of this disclosure and the subject matter therein forms a part of the specification of this application.

### DETAILED DESCRIPTION

Various aspects of the disclosure are described more fully hereinafter with reference to the accompanying drawings and appendix. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatus, methods, and computer-readable media for supporting multiple cross-link interference (CLI) measurements on multiple CLI resources. For example, the multiple CLI resources may include multiple sounding reference signal (SRS) resources, such as multiple SRS ports. To illustrate, in some implementations, a user equipment (UE) may receive a CLI resource configuration indicating the multiple CLI resources configured for the UE. In some implementations, the CLI resource configuration may define multi-port SRS resources for the UE, such as a victim UE to measure CLI. A number of ports for the multi-port SRS resources may be the same or fewer than a number of ports of a corresponding SRS from an aggressor UE. The UE may perform a one or more CLI measurements on each of multiple ports to determine a plurality of measurement values for the plurality of CLI resources. The UE may then transmit, to the base station, a CLI measurement report based on the plurality of measurement values.

In some other implementations, the multiple CLI resources, such as the multiple SRS ports, are configured to be time division multiplexed across multiple slots, multiple symbols, or a combination thereof. For example, the UE may be configured to switch amongst different CLI resources or different CLI resource combinations for different slots, different symbols, or a combination thereof. Additionally, or alternatively, the UE may be configured to switch amongst the multiple CLI resources based on or according to a pattern. For example, the pattern may be received at the UE from the base station, be a patterned defined by a standard, or determined by the UE.

In some implementations, the UE may determine a CLI measurement for each CLI resource, such as each SRS port, individually and report one or more individual CLI measurement values. In some other implementations, the UE may combine one or more CLI measurement values and report a combined value. To combine the CLI measurement values, the UE may average measurements across the multiple CLI resources, determine a maximum measurement across the multiple CLI resources, or a combination thereof. Additionally, or alternatively, the UE may determine a combined measurement per slot, per symbol, or a combination thereof.

In some implementations, the UE may also include multiple receive (RX) antennas. In some such implementations, the UE may combine measurements form the multiple RX antenna, such as from multiple RX antenna ports. For example, the UE may average measurements across the multiple RX antenna, determine a maximum of measurements across the multiple RX antennas, or a combination thereof. Additionally, or alternatively, the UE may combine the measurements of the multiple RX antenna according to an identified precoder or beam. The precoder or beam may be indicated by the base station via an indicator. For example, the UE may receive a radio resource control (RRC), a medium access control (MAC)-control element (CE), or downlink control information (DCI) from the base station that includes the indicator. In some implementations, the measurements of the RX antenna and the measurements of the multiple CLI resources may both be combined. For example, the measurements of the RX antenna may be combined before or after the measurements of the multiple CLI resources are combined.

Particular implementations of the subject matter described in this disclosure can be implemented to realize one or more of the following potential advantages. In some aspects, the present disclosure provides techniques for supporting multiple CLI measurements on multiple CLI resources, such as multiple SRS resources. Performing multiple CLI measurements on multiple CLI resources may enable the UE to better detect CLI from an aggressor UE. Additionally, by combining or aggregating multiple CLI measurement values into one or more representative values, the UE may report to the base station the measured CLI using less overhead than if the UE reports each CLI measurement for each CLI resource, which may improve an available system bandwidth in a wireless communication system.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator’s network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ~1 M nodes per km2), ultra-low complexity (such as ~10 s of bits per sec), ultra-low energy (such as ~10+ years of battery life), and deep coverage with the capability to reach challenging locations; (2) including mission-critical control with strong security to safeguard sensitive personal, financial, or classified information, ultra-high reliability (such as -99.9999% reliability), ultra-low latency (such as ~ 1 millisecond (ms)), and users with wide ranges of mobility or lack thereof; and (3) with enhanced mobile broadband including extreme high capacity (such as ~ 10 Tbps per km2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

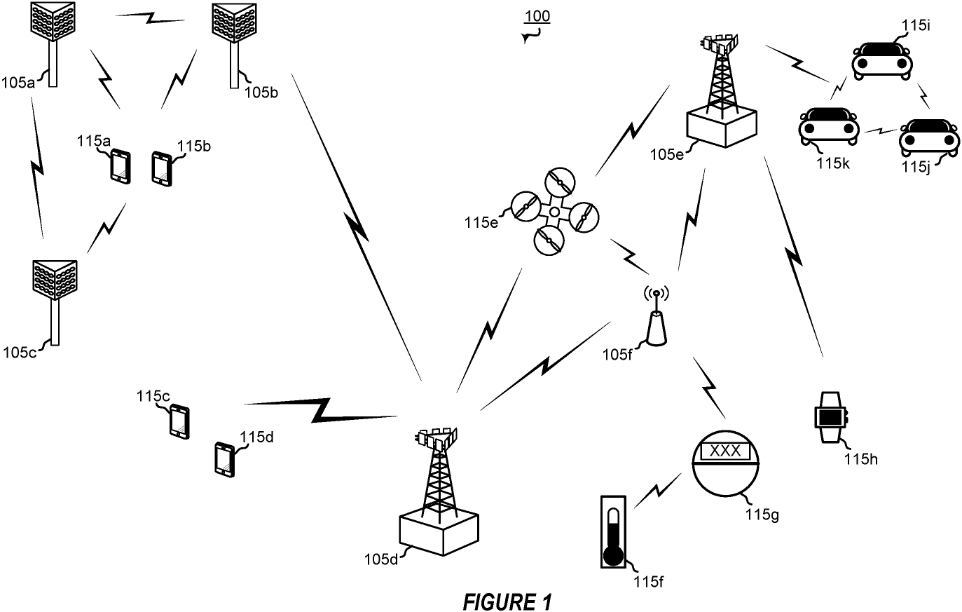

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

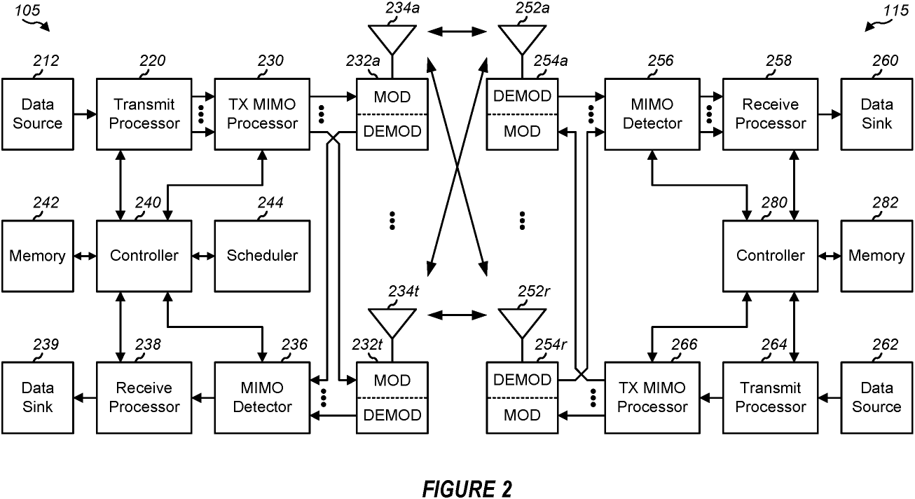

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

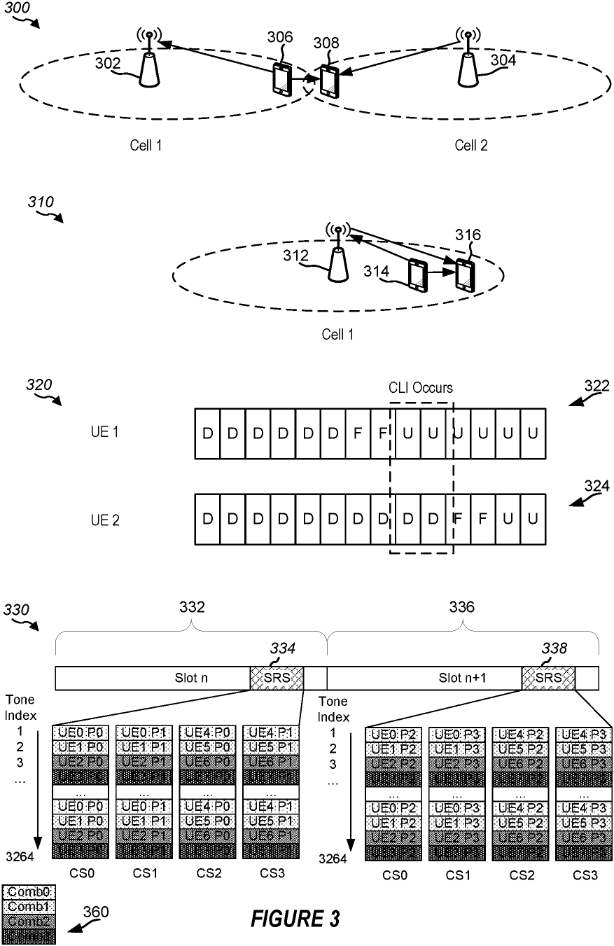

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIGS. 3-11 and 13-16, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

FIG. 3 is a diagram illustrating examples related to CLI. For example, FIG. 3 shows a first wireless communication system 300. The first wireless communication system 300 may include a first base station 302, a second base station 304, a first UE 306, and a second UE 308. The first base station 302 may be configured to provide a first cell “Cell 1” and the second base station 304 may be configured to provide a second cell “Cell 2.”

A nearby UE, referred to as an “aggressor UE,” may cause CLI for another UE, referred to as a “victim UE,” if the UEs are assigned different uplink-downlink (UL-DL) slot formats. For example, the first UE 306 may cause CLI for the second UE 308 if a UL transmission from the first UE 306 collides with a DL transmission to the second UE 308. The CLI may occur even though the first UE 306 and the second UE 308 are within different cells.

FIG. 3 also shows a second wireless communication system 310. The second wireless communication system 310 may include a base station 312, a first UE 314, and a second UE 316. The base station 312 may be configured to provide a cell “Cell 1.” When the first UE 314 is nearby to the second UE 316 within the cell, the first UE 314 may cause CLI for the second UE 316 if the UEs are assigned different UL-DL slot formats.

FIG. 3 further shows illustrative slot formats 320 associated with occurrence of CLI. The slot formats 320 include a first slot format 322 associated with a first UE, such as the first UE 306 or the first UE 314, and a second slot format 324 associated with a second UE, such as the second UE 308 or the second UE 316. The first slot format 322 may be different from the second slot format 324. For example, one or more OFDM symbols of the first slot format 322 may be scheduled for UL transmissions, while one or more OFDM symbols of the second slot format 324 may be scheduled for DL reception. To illustrate, the ninth and tenth OFDM symbols of the first slot format 322 may be scheduled for UL transmission and the ninth and tenth OFDM symbols of the second slot format 324 may be scheduled for DL reception. Due to the scheduling, a UL symbol from the first UE may collide with a DL symbol to the second UE, causing CLI for the second UE. The CLI may be caused by any type of UL transmission from the first UE, such as a physical uplink control channel (PUCCH) transmission, a physical uplink shared channel (PUSCH) transmission, a random access channel (RACH) transmission, or a SRS transmission.

To enable measurement of the CLI, the victim UE, such as the second UE 308 or the second UE 316, receives a CLI resource configuration from the network. The victim UE may then perform a CLI measurement using the configured CLI resource and may transmit a CLI measurement report to the network based on the CLI measurement. Because the network configures the CLI resource, the victim UE does not need to know the time domain UL/DL configuration (the slot format) or the SRS transmission configuration of the aggressor UE. The network may receive the CLI measurement report and perform one or more operations, such as changing the slot format or the SRS transmission configuration of the aggressor UE, to reduce the CLI measured at the victim UE.

FIG. 3 also shows an example of port mapping for an SRS configuration, which is generally designated 330. The SRS configuration 330 includes a number of resource blocks and a number of physical resources/ports. In some implementations, 1 symbol SRS with up to 16 orthogonal ports may be supported in a first configuration with comb level = 4 and cyclic shift = 4, or in a second configuration with comb level = 2 and cyclic shift = 8. Additionally, or alternatively, a number of SRS antenna ports may be 1, 2, or 4, a number of OFDM symbols allocated for SRS per slot may be 1, 2, or 4, or a combination thereof.

As shown at 330, the port mapping is shown for a first slot 332 (slot n) and a second slot 336 (slot n+1). The first slot 332 includes a first SRS 334 and the second slot 336 includes a second SRS 338. Additionally, the port mapping for a combination level of 4, 4 cyclic shifts, and two antenna ports per slot with time division multiplexing. Further, the multiple ports are organized by cyclic shift (CS).

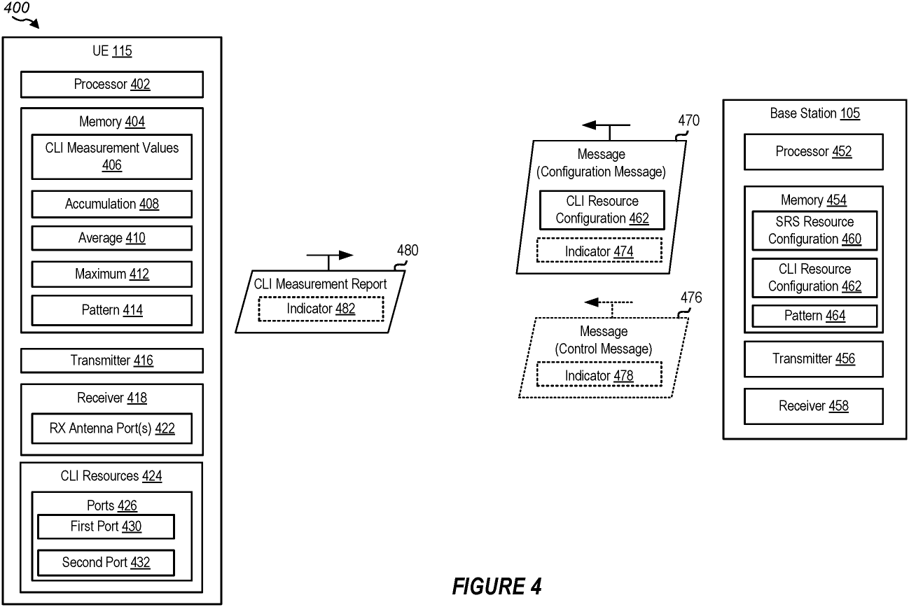

FIG. 4 is a block diagram of an example wireless communications system 400 that supports performing CLI measurements on multiple CLI resources according to some aspects. In some examples, the wireless communications system 400 may implement aspects of the wireless network 100. The wireless communications system 400 includes the UE 115 and the base station 105. Although one UE 115 and one base station 105 are illustrated, in some other implementations, the wireless communications system 400 may generally include multiple UEs 115, and may include more than one base station 105.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transmitters 416 (hereinafter referred to collectively as “the transmitter 416”), one or more receivers 418 (hereinafter referred to collectively as “the receiver 418”), and CLI resources 424. The processor 402 may be configured to execute instructions stored in the memory 404 to perform the operations described herein. In some implementations, the processor 402 includes or corresponds to one or more of the receive processor 258, the transmit processor 264, and the controller 280, and the memory 404 includes or corresponds to the memory 282.

In some implementations, the memory 404 is configured to store CLI measurement values 406, an accumulation value 408, an average value 410, a maximum value 412, a pattern 414, or a combination thereof. The UE 115 may generate the CLI measurement values 406 by performing CLI measurements on the CLI resources 424, as further described herein. The accumulation value 408 may be an accumulation or sum of one or more of the CLI measurement values 406. The average value 410 may be an arithmetic or geometric average of one or more of the CLI measurement values 406. The maximum value 412 may be a largest value of one or more of the CLI measurement values 406. The pattern 414 may include a pattern or scheme for switching between or amongst different CLI resources, such as different SRS resources.

The transmitter 416 is configured to transmit reference signals, control information and data to one or more other devices, and the receiver 418 is configured to receive references signals, synchronization signals, control information and data from one or more other devices. For example, the transmitter 416 may transmit signaling, control information and data to, and the receiver 418 may receive signaling, control information and data from, the base station 105. In some implementations, the transmitter 416 and the receiver 418 may be integrated in one or more transceivers. Additionally or alternatively, the transmitter 416 or the receiver 418 may include or correspond to one or more components of the UE 115 described with reference to FIG. 2. In some implementations, the receiver 418 includes one or more receive (RX) antennas, one or more RX antenna ports 422, or a combination thereof. An antenna port is defined such that the channel over which a symbol on the antenna port is conveyed can be inferred from the channel over which another symbol on the same antenna port is conveyed. In some implementations, the antenna port(s) may be physical or logical.

The CLI resources 424 may include one or more SRS resources, such as one or more SRS ports. Each CLI resource 424 may be configured for CLI measurements.

The base station 105 can include a variety of components (such as structural, hardware components) used for carrying out one or more functions described herein. For example, these components can include one or more processors 452 (hereinafter referred to collectively as “the processor 452”), one or more memory devices 454 (hereinafter referred to collectively as “the memory 454”), one or more transmitters 456 (hereinafter referred to collectively as “the transmitter 456”), and one or more receivers 458 (hereinafter referred to collectively as “the receiver 458”). The processor 452 may be configured to execute instructions stored in the memory 454 to perform the operations described herein. In some implementations, the processor 452 includes or corresponds to one or more of the receive processor 238, the transmit processor 220, and the controller 240, and the memory 454 includes or corresponds to the memory 242.

The memory 454 may include one or more SRS resource configurations 460 (hereinafter referred to collectively as “the SRS resource configuration 460”), one or more CLI resource configurations 462 (hereinafter referred to collectively as “the CLI resource configuration 462”), one or more patterns 464 (hereinafter referred to collectively as “the pattern 464”). The SRS resource configuration 460 may include a configuration for a UE, such as the UE or another UE, to transmit one or more SRSs. The CLI resource configuration 462 may include a configuration of CLI resources, such as the CLI resources 424. As an illustrative, non-limiting example, the CLI resource configuration 462 may indicate multiple SRS ports for the UE 115 to perform CLI measurements. The pattern 464 may include a pattern or scheme for switching between or amongst different CLI resources, such as different SRS resources. For example, the pattern 464 may include or correspond to the pattern 414.

The transmitter 456 is configured to transmit reference signals, synchronization signals, control information and data to one or more other devices, and the receiver 458 is configured to receive reference signals, control information and data from one or more other devices. For example, the transmitter 456 may transmit signaling, control information and data to, and the receiver 458 may receive signaling, control information and data from, the UE 115. In some implementations, the transmitter 456 and the receiver 458 may be integrated in one or more transceivers. Additionally or alternatively, the transmitter 456 or the receiver 458 may include or correspond to one or more components of base station 105 described with reference to FIG. 2.

In some implementations, the wireless communications system 400 implements a 5G New Radio (NR) network. For example, the wireless communications system 400 may include multiple 5G-capable UEs 115 and multiple 5G-capable base stations 105, such as UEs and base stations configured to operate in accordance with a 5G NR network protocol such as that defined by the 3GPP.

During operation of the wireless communications system 400, the base station 105 may communicate with the UE 115 to configure one or more resources of the UE 115. In some implementations, the base station 105 may also select the SRS resource configuration 460 for another UE. The SRS resource configuration 460 may include or correspond to SRS scheduling for the other UE to perform one or more SRS transmissions. The base station 105 may send a message to the other UE that includes or indicates the SRS resource configuration 460, such as the SRS scheduling.

The base station 105 may select the CLI resource configuration 462 for configuring for the UE 115 for SRS measurements. In some implementation, the base station 105 may select the CLI resource configuration 462 based on the SRS resource configuration 460. Additionally, or alternatively, the base station 105 may select the CLI resource configuration 462 based on receiving an indication of CLI or a previous CLI measurement report from the UE 115 and based on information generated by or received by the base station 105, such as historical interference information or historical CLI measurement reports received from the UE 115, position data associated with other UEs served by the base station 105, slot formats assigned to the UE 115 and to the other UEs, other information, or a combination thereof. The base station 105 send a message 470, such as a configuration message, to the UE 115. The message may include or indicate the CLI resource configuration 462.

In some implementations, the base station 105 may select the pattern 464 for use with the CLI resource configuration 462. The base station 105 may generate an indicator 474 corresponding to the pattern 464. The base station 105 may send the indicator 474 to the UE 115. For example, the base station 105 may optionally (as indicated by the dashed box) include the indicator 474 in the message 472. In some implementations, the indicator 474 may be included in the CLI resource configuration 462. As another example, the indicator 474 may be sent to the UE 115 in another message that is distinct from the message 470.

The UE 115 may receive the message 470 and configure the CLI resources 424 based on the CLI resource configuration 462. For example, the UE 115 may configure the ports 426, such as the first port 430 and the second port 432. To illustrate, the UE 115 may configure multiple SRS ports (e.g., 426).

The UE 115 may perform one or more CLI measurements on each of the CLI resources 424. To illustrate, the UE 115 may perform one or more CLI measurements on the first port 430 and the second port 432. The UE 115 may determine the CLI measurement values 406 based on the CLI measurements.

In some implementations, the UE 115 may determine the pattern 414. For example, the UE 115 may receive the indicator 474 and identify the pattern based on the indicator 474. Alternatively, the UE 115 may select the pattern 414 independent of an indication or instruction received from the base station 105. In some implementations, the pattern 414 may be specified by a standard. The UE 115 may perform the one or more CLI measurements on each of the CLI resources 424 based on the pattern 414.

Based on the one or more CLI measurement values 406, the UE 115 may generate and send a CLI measurement report 480. The CLI measurement report 480 may include the CLI measurement values 406, the accumulation value 408, the average value 410, the maximum value 412, or a combination thereof. In some implementations, the CLI measurement report 480 may optionally (as indicated by the dashed box) include one or more indicators 482. The one or more indicators 482 may indicate which CLI measurement values 406 correspond to which port 426 or combination of ports 426. In some implementations, the UE 115 may generate the CLI measurement report 480 based on measurements received via multiple RX antennas, such as the RX antenna ports 422.

In some implementations, the base station 105 may optionally (as indicated by the dashed box) send a message 476, such as a control message, to the UE 115. The message 476 may include or correspond to a radio resource control (RRC), a medium access control (MAC)-control element (CE), or downlink control information (DCI). The message 476 may include an indicator 478. The indicator 478 may correspond to a precoder or a beam for combining measurements from multiple RX antennas, such as the RX antenna ports 422. In some such implementations, the UE 115 may generate the CLI measurement report 480 based on the precoder or the beam.

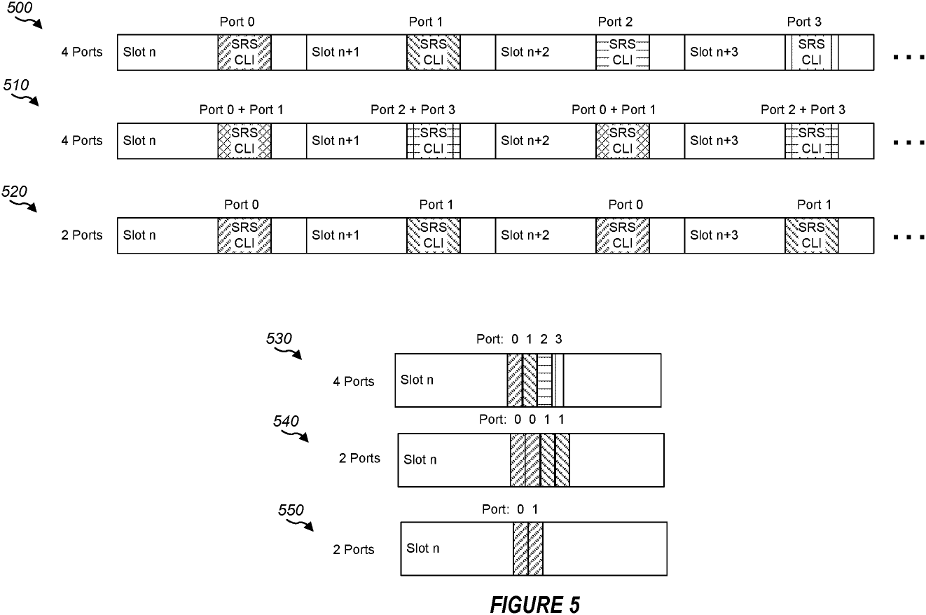

In some implementations, the UE 115 may perform CLI measurements on the multiple CLI resources, such as multiple ports, based on time division multiplexing (TDM), which may enable the UE to process the multiple CLI resources. In such implementations, and as described herein with reference to FIG. 5, each port may be a single port, such that a CLI resource is equivalent to a resource port. According, references to combining multiple resources may be understood as combining ports. For example, the UE 115 may be configured to switch CLI resources based on the CLI resource configuration. To illustrate, the UE 115 may be configured to switch CLI resources for different slots, for different symbols, or a combination thereof. In some implementations, the multiple CLI resources may be assigned to different slots. For example, multiple CLI resources, such as the multiple ports, in one slot may be symbol-based or CS-based. In implementations where the multiple CLI resources are switched in symbols, the multiple CLI resources may be orthogonal in the symbol levels.

Referring to FIG. 5, a diagram is shown illustrating examples of CLI measurements on multiple CLI resources according to some aspects. Examples of TDM methods to support multiple CLI resource measurements, such as multiple port measurements, are shown at 500, 510, 520, 530, 540, 550. Examples of using CLI resources for different slots is shown at 500, 510, 520 and examples of using CLI resources for different symbols is shown at 530, 540, 550.

At example 500, the CLI resources 424 include four ports - a first port 0, a second port 1, a third port 2, and a fourth port 3. The ports are used for different slots. To illustrate, the first port 0 is used for CLI measurements during a slot n, the second port 1 is used for CLI measurements during slot n+1, the third port 2 is used for CLI measurements during slot n+2, and the fourth port 3 is used for CLI measurements during slot n+3.

At example 510, the CLI resources 424 include four ports - a first port 0, a second port 1, a third port 2, and a fourth port 3. Two or more ports are used for different slots. To illustrate, the first port 0 and the second port 1 are used for CLI measurements during a slot n and slot n+2, and the third port 2 and fourth port 3 are used for CLI measurements during slot n+1 and slot n+3.

At example 520, the CLI resources 424 include two ports - a first port 0 and a second port 1. The ports are used for different slots. To illustrate, the first port 0 is used for CLI measurements during a slot n, the second port 1 is used for CLI measurements during slot n+1, the first port 0 is used for CLI measurements during slot n+2, and the second port 1 is used for CLI measurements during slot n+3.

At example 530, the CLI resources 424 include four ports - a first port 0, a second port 1, a third port 2, and a fourth port 3. The ports are used for different symbols within slot n. To illustrate, the first port 0 is used for CLI measurements during a first symbol, the second port 1 is used for CLI measurements during a second symbol, the third port 2 is used for CLI measurements during a third symbol, and the fourth port 3 is used for CLI measurements during a fourth symbol.

At example 540, the CLI resources 424 include two ports - a first port 0 and a second port 1. The ports are used for different symbols within slot n. To illustrate, the first port 0 is used for CLI measurements during a first symbol and a second symbol, and the second port 1 is used for CLI measurements during a third symbol and a fourth symbol.

At example 550, the CLI resources 424 include two ports - a first port 0 and a second port 1. The ports are used for different symbols within slot n. To illustrate, the first port 0 is used for CLI measurements during a first symbol, and the second port 1 is used for CLI measurements during a second symbol.

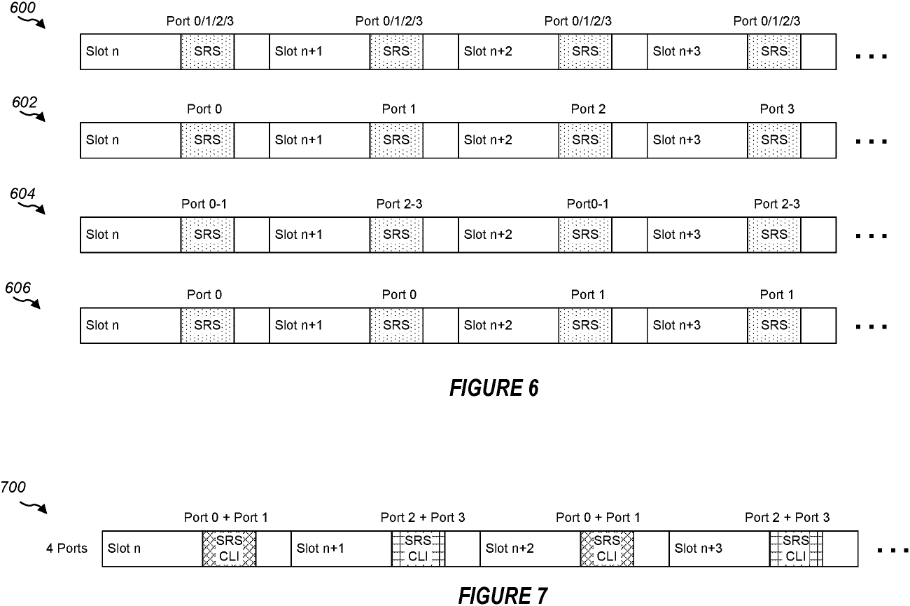

Referring again to FIG. 4, in some implementations, the base station 105 may configure the CLI resources 424, such as the multiple ports 426, of the UE 115 for CLI measurements. For example, the CLI resources 424 (or the multiple ports 426) may be configured to have the same time domain configuration across the multiple ports. In such implementations, and as described herein with reference to FIG. 6, a CLI resource includes multiple ports and, for a CLI resource, two or more ports of the multiple ports of the CLI resource may be combined. According, if ports are combined, ports of the CLI resource are combined and not ports of different CLI resources. The UE 115 may use the pattern, 414, 464 to measure a subset of CLI resources 424 (or a subset of the multiple ports 426). For example, the base station 105 may configure the pattern 414, 464 for UE 115 to switch CLI resources or ports. The pattern 414, 464 indicated by the base station 105 may include or correspond to patterns (or schemes) descried with reference to port switching examples 500, 510, 520, 530, 540, 550. In some implementations, the base station 105 may configure one CLI resource (e.g., one port) per slot and the UE 115 may only perform one CLI measurement per slot and switch CLI resources with each slot. As another example, the UE 115 may follow a predefined pattern (e.g., 414, 464) as defined in standard. For example, the standard may indicate a number of CLI resources per slot, such as two or more CLI resources per slot (or two or more ports per slot). In some implementations, the pattern defined by the standard may correspond to a transmission patter, such as an SRS transmission pattern, defined by the standard. As another example, the UE 115 may determine which pattern to implement to switch CLI resources or ports. To illustrate, the UE 115 may have one or more constraints on CLI resource switching, such as one or more constrains on antenna or port switching. Based on the one or more constraints, the UE 115 may be limited on which CLI resources may be switch. To illustrate, the UE 115 may only be able to switch ports in two slots or after using a CLI resource for two slots. Accordingly, the UE 115 switch the CLI resources in accordance with the constraints.

Referring to FIG. 6, a diagram is shown illustrating examples of CLI measurement patterns according to some aspects. For example, a slot configuration and the multiple configured CLI resources (e.g., 424), such as multiple configured ports, are shown at example 600. For each SRS of each slot (e.g., slots n - n+3), the UE 115 may be configured to use one or more of a first port 0, a second port 1, a third port 2, or a fourth port 3. In some implementations, the pattern may include or correspond to the use of CLI resources as described with reference to the examples 500, 510, 520, 530, 540, 550 of FIG. 5 and may be a slot pattern, a symbol pattern, or a combination thereof.

A first example switching pattern is shown at 602. The first example switching pattern 602 may include or correspond to a pattern determined by the base station 105. In the first example switching pattern 602, the UE 115 is configured to switch CLI ports with each slot. To illustrate, the UE 115 is configured to measure the first port 0 during slot n, the second port 1 during slot n+1, the third port 2 during slot n+2, and the fourth port 3 during slot n+3.

A second example switching pattern is shown at 604. The second example switching pattern 604 may include or correspond to a pattern defined based on a standard. In the second example switching pattern 604, the UE 115 is configured to use two CLI ports, per slot. To illustrate, the UE 115 is configured to measure the first port 0 and the second port 1 during each of slot n and slot n+2, and measure the third port 2 and the fourth port 3 during each of slot n+1 and slot n+3.

A third example switching pattern is shown at 606. The third example switching pattern 606 may include or correspond to a switching pattern determined by the UE 115, such as based on one or more operational or switching constraints. In the third example switching pattern 606, the UE 115 is configured to switch CLI ports for two slots. To illustrate, the UE 115 is configured to measure the first port 0 for slot n and slot n+1, and to measure the second port 1 for slot n+2 and slot n+3.

Referring again to FIG. 4, in some implementations, the UE 115 may measure multiple CLI resource ports in the same slot or the same symbol. In such implementations, and as described herein with reference to FIG. 7, a CLI resource includes multiple ports and, for a CLI resource, two or more ports of the multiple ports of the CLI resource may be combined. According, if ports are combined, ports of the CLI resource are combined and not ports of different CLI resources. For example, the UE 115 may measure and report two CLI resource ports in the same symbol and report each CLI resource individually (e.g., separately). As another example, the UE 115 may measure two or more CLI resource ports in the symbol and combine the measurement of the two or more CLI resource ports. To illustrate, the UE 115 may average the measurements from the two or more CLI resource ports or may determine a maximum of the measurements from the two or more CLI resource ports.

Referring to FIG. 7, a diagram is shown illustrating an example 700 of CLI measurements on multiple CLI resources according to some aspects. In example 700, the UE 115 is configured to use two CLI resource ports, per slot (e.g., per symbol).

In a first implementation of the example, the UE 115 is configured to measure the first port 0 and the second port 1 during each of slot n and slot n+2, and measure the third port 2 and the fourth port 3 during each of slot n+1 and slot n+3. In some implementations, the UE 115 may measure and report measurement for each port separately. For example, the UE 115 may separately measure and report a CLI measurement value for each of the first port 0 and the second port 1 for slot n, separately measure and report a CLI measurement value for each of the third port 2 and the fourth port 3 for slot n+1, separately measure and report a CLI measurement value for each of the first port 0 and the second port 1 for slot n+2, and separately measure and report a CLI measurement value for each of the third port 2 and the fourth port 3 for slot n+3.

In a second implementation of the example 700, the UE is configured to combine measurements of two or more ports and report the combined CLI value. For example, the UE 115 may report an average of the two or more ports. To illustrate, the UE 115 may average measurements for the first port 0 and the second port 1 for slot n and report the average CLI value for slot n, average measurements for the third port 2 and the fourth port 3 for slot n+1 and report the average CLI value for slot n+1, average measurements for the first port 0 and the second port 1 for slot n+2 and report the average CLI value for slot n+2, and average measurements for the third port 2 and the fourth port 3 for slot n+3 and report the average CLI value for slot n+3. As another example, the UE 115 may report a maximum of the two or more ports. To illustrate, the UE 115 may determine a maximum of measurements for the first port 0 and the second port 1 for slot n and report the maximum CLI value for slot n, a maximum of measurements for the third port 2 and the fourth port 3 for slot n+1 and report the maximum CLI value for slot n+1 a maximum of measurements for the first port 0 and the second port 1 for slot n+2 and report the maximum CLI value for slot n+2, and a maximum of measurements for the third port 2 and the fourth port 3 for slot n+3 and report the maximum CLI value for slot n+3. For example, the first port 0 may have the maximum in slot n and the second port 1 may have the maximum in slot n+2.

Referring again to FIG. 4, in some implementations, the UE 115 includes multiple RX antennas, such as the multiple RX antenna ports 422. The UE 115 may be configured to combine measurements from the multiple RX antennas. To illustrate, the UE 115 may be configured to combine measurements from the multiple RX antenna ports 422. For example, to combine the measurements, the UE 115 may be configured to average of measurements across the multiple RX antennas. As another example, to combine the measurements, the UE 115 may be configured to determine a maximum measurement across the multiple RX antennas. As an additional example, to combine the measurements, the UE 115 may be configured to use a specific precoder or beam as indicated by the base station 105. To illustrate, the base station 105 may send the indicator 478 to the UE 115 that indicates the precoder or the beam. In some implementations, the indicator 478 may be included in a control message, such as an RRC, a MAC-CE, or DCI. In some other implementations, the indicator 478 may be included together with the configuration/activation of the CLI-SRS-resource for the UE 115, such as in the message 470 or in another message.

In some implementations, combining measurements of the CLI resources 424, such as the ports 426, may be performed in addition to combining measurements of RX antennas. For example, the measurements of the multiple CLI resources 424 may be performed prior to combining the measurements of the multiple RX antenna. As another example, the measurements of the multiple RX antenna may be combined prior to combining the measurements from the multiple CLI resources 424.

As described with reference to FIG. 4, the present disclosure provides techniques for enabling the UE 115 to perform CLI measurements on the multiple CLI resources 424. Performing the CLI measurements on the multiple CLI resources 424 enables the UE 115 to perform CLI measurements to measure CLI from multiple SRS from an aggressor UEs. For example, the present disclosure provides techniques for supporting multiple CLI measurements on multiple CLI resources, such as multiple SRS resources. Performing multiple CLI measurements on multiple CLI resources may enable the UE to better detect CLI from an aggressor UE. In some other implementations, the CLI measurement report 480 only includes the accumulation value 408, the average value 410, the maximum value 412, or a combination thereof, which reduces the size of the CLI measurement report compared to conventional CLI measurement reports. Reducing the size of the CLI measurement report 480 may reduce overhead and increase an available system bandwidth of the wireless communications system 400.

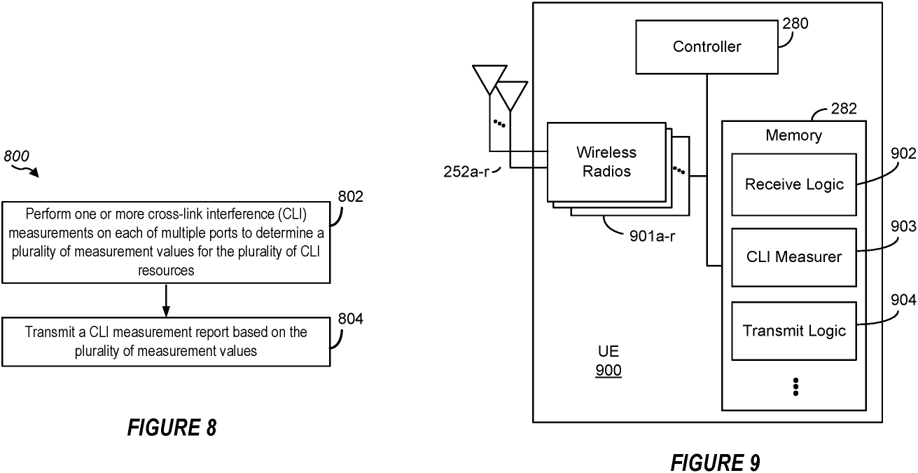

FIG. 8 is flow diagrams illustrating an example process 800 that supports performing CLI measurements on multiple CLI resources according to some aspects. Operations of the process 800 may be performed by a UE, such as the UE 115 described above with reference to FIGS. 1, 2, or 4, or the UE 306, 308, 314, 316 of FIG. 3. For example, example operations (also referred to as “blocks”) of the process 800 may enable the UE to perform CLI measurements on multiple CLI resources, such as multiple SRS ports.

FIG. 9 is a block diagram of an example UE 900 that supports performing CLI measurements on multiple CLI resources according to some aspects. The UE 900 may be configured to perform operations, including the blocks of the process 800 described with reference to FIG. 8, to perform CLI measurements on multiple CLI resources. In some implementations, the UE 900 includes the structure, hardware, and components shown and described with reference to the UE 115 of FIGS. 1, 2, or 4, or the UE 306, 308, 314, 316 of FIG. 3. For example, the UE 900 includes the controller 280, which operates to execute logic or computer instructions stored in the memory 282, as well as controlling the components of the UE 900 that provide the features and functionality of the UE 900. The UE 900, under control of the controller 280, transmits and receives signals via wireless radios 901a-r and the antennas 252a-r. The wireless radios 901a-r include various components and hardware, as illustrated in FIG. 2 for the UE 115, including the modulator and demodulators 254a-r, the MIMO detector 256, the receive processor 258, the transmit processor 264, and the TX MIMO processor 266.

As shown, the memory 282 may include receive logic 902, CLI measurer 903, and transmit logic 904. The receive logic 902 may be configured to receive messages from a base station, such as messages including CLI resource configurations. The CLI measurer 903 may be configured to perform one or more CLI measurements based on configured CLI resources. The transmit logic 904 may be configured to initiate transmission of messages to the base station, such as CLI measurement reports. The UE 900 may receive signals from or transmit signals to one or more network entities, such as the base station 105 of FIGS. 1, 2, or 4, the base station 302, 204, 312 of FIG. 3, or a base station as illustrated in FIG. 11.

Referring back to FIG. 8, FIG. 8 is a flow diagram illustrating a process 800 that supports performing CLI measurements on multiple CLI resources according to some aspects. In block 802, the UE 900 performs one or more CLI measurements on each of multiple ports to determine a plurality of measurement values for the multiple ports. To illustrate, the UE 900 may execute, under control of the controller 280, the CLI measurer 903 stored in the memory 282. The execution environment of the CLI measurer 903 provides the functionality to perform a respective CLI measurement on each of the multiple CLI resources.

In some implementations, the multiple ports may include or correspond to the CLI resources 424 or the ports 426. For example, the multiple ports include multiple sounding reference signal (SRS) resources. The multiple ports may include the same or fewer number of ports of sound reference signals from an aggressor UE. Additionally, or alternatively, the multiple ports may be configured to be time division multiplexed across multiple slots, multiple symbols, or a combination thereof. In some implementations, the multiple ports may have the same time domain configuration as sounding reference signals (SRS) transmissions of from an aggressor UE. Each of the multiple ports also may be configured to be assigned to a different transmission slot. In some implementations, a single port or a plurality of ports of the multiple ports is assigned to a one slot. Additionally, or alternatively, the plurality of ports assigned to the one slot have a symbol-based assignment or a cyclic shift (CS)-based assignment.

In block 804, the UE 1200 transmits a CLI measurement report based on the plurality of measurement values. In some implementations, the CLI measurement report is transmitted to the base station. To illustrate, the UE 900 may execute, under control of the controller 280, the transmit logic 904 stored in the memory 282. The execution environment of the transmit logic 904 provides the functionality to transmit the CLI measurement report.

In some implementations, the UE receives, from a base station, a message including a CLI resource configuration indicating the multiple ports. The base station may include or correspond to the base station 105 of FIGS. 1, 2, or 4, the base station 302, 304, 312 of FIG. 3, or the base station 1100 of FIG. 11. To illustrate, the UE 900 may execute, under control of the controller 280, the receive logic 902 stored in the memory 282. The execution environment of the receive logic 902 provides the functionality to receive a message including the CLI resource configuration.

In some implementations, performing the one or more CLI measurements on each of multiple ports includes the UE 900 performing a first set of one or more CLI measurements during a first slot using a first set of one or more ports of the multiple ports. Additionally, performing the one or more CLI measurements on each of multiple ports may also include the UE performing a second set of one or more CLI measurements during a second slot using a second set of one or more ports of the multiple ports. The first set of one or more ports may be different from the second set of one or more ports.

In some other implementations, the UE 900 may perform a third set of one or more CLI measurements during a third slot using the first set of one or more ports, or perform a fourth set of one or more CLI measurements during a fourth slot using the second set of one or more ports. Alternatively, the UE 900 may perform a third set of one or more CLI measurements during a third slot using a third set of one or more ports of the multiple ports, or perform a fourth set of one or more CLI measurements during a fourth slot using a fourth set of one or more ports of the multiple ports. In some implementations, each of the first set of one or more ports and the second set of one or more ports includes a single port.

In some implementations, to perform the one or more CLI measurements on each of multiple ports, the UE 900 performs a first CLI measurement during a first symbol of a plurality of symbols using a first port of the multiple ports. Additionally, or alternatively, to perform the one or more CLI measurements on each of multiple ports, the UE 900 performs a second CLI measurement during a second symbol of the plurality of symbols using a second port of the multiple ports.

In some implementations, the plurality of symbols are included in a single slot, the first symbol and the second symbol are consecutive symbols, the first port and the second port are different ports, or a combination thereof. To illustrate, the multiple ports may be switched orthogonally by symbol level to perform the one or more CLI measurements.

In some implementations, to perform the one or more CLI measurements on each of multiple ports, the UE 900 selects one or more ports for a CLI measurement according to a pattern. The pattern may include a port switching pattern per slot, per symbol, or a combination thereof. For example, the pattern may indicate to use one port per slot, indicates to switch ports each slot, indicates to switch ports each symbol, or a combination thereof. In some implementations, the message includes an indication of the pattern. Additionally, or alternatively, the pattern is defined by a standard or determined by the UE 900.

In some implementations, to perform the multiple CLI measurements, the UE 900 performs a first set of CLI measurements using a first port of the multiple ports and a second port of the multiple ports during the same symbol. The first port and the second port may include or correspond to the first port 430 and the second port 432, respectively. The UE 900 may also generate the CLI measurement report to indicate a first CLI measurement from the first port and a second CLI measurement from the second port.

In some implementations, the UE 900 may combine a first CLI measurement from the first port and a second CLI measurement from the second port to generate a combined CLI measurement, and generate the CLI measurement report to indicate the combined measurement. To combine the first CLI measurement from the first port and the second CLI measurement from the second port, the UE 900 may average the first CLI measurement and the second CLI measurement, aggregate the first CLI measurement and the second CLI measurement, or select the maximum of the first CLI measurement and second CLI measurement as the combined measurement.

In some implementations, the multiple CLI measurements may be performed via multiple RX antenna ports. The UE 900 may average measurements received via a set of RX antenna ports of the multiple RX antenna ports, determine a maximum measurement of a set of RX measurements received via a set of RX antenna ports of the multiple RX antenna ports, or combine a set of RX measurements received via a set of Rx antenna ports of the multiple RX antenna ports using a precoder or a beam. In some implementations, the UE 900 may receive, from a base station, an indicator corresponding to the precoder or the beam. For example, the UE 900 may receive an RRC, a MAC-CE, or DCI that includes the indicator. Additionally, or alternatively, the UE 900 may receive, from a base station, a message including a CLI resource configuration indicating the multiple ports, and the message may include the indicator.

In some implementations, the UE 900 may combine a set of CLI measurements from a set of port of the multiple ports, and combine a set of RX measurements from a set of the RX antenna ports of the multiple RX antenna ports. For example, the set of CLI measurements may be combined prior to the set of RX measurements being combined. As another example, the set of RX measurements may be combined prior to the set of CLI measurements being combined.

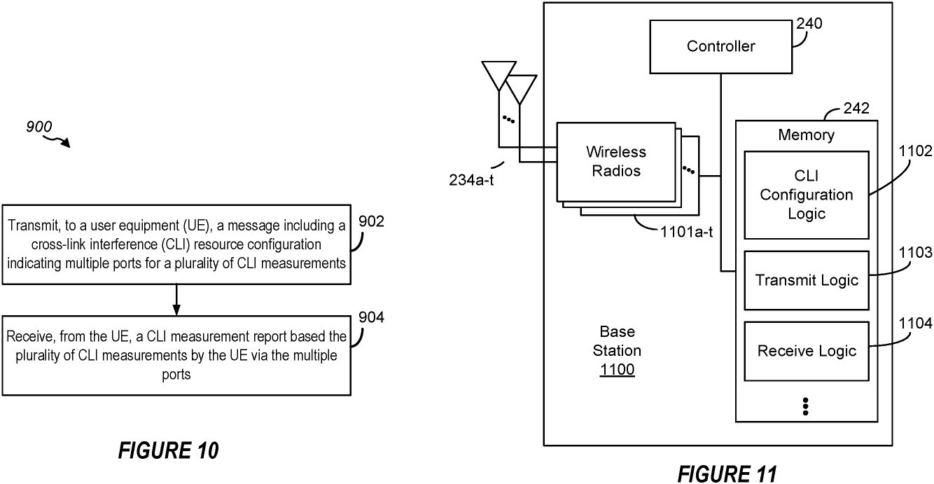

FIG. 10 is a flow diagram illustrating an example process 1000 supports configuring CLI resources to enable CLI measurements on multiple CLI resources according to some aspects. Operations of the process 1000 may be performed by a base station, such as the base station 105 described above with reference to FIGS. 1, 2, or 4, or the base station 302, 304, 312 of FIG. 3. For example, example operations of the process 1000 may enable a base station to configure CLI resources for a UE.

FIG. 11 is a block diagram of an example base station 1100 that supports configuring CLI resources according to some aspects. The base station 1100 may be configured to perform operations, including the blocks of the process 1000 described with reference to FIG. 10, to configure CLI resources. In some implementations, the base station 1100 includes the structure, hardware, and components shown and described with reference to the base station 105 of FIGS. 1, 2, or 4, or the base station 302, 304, 312 of FIG. 3. For example, the base station 1100 may include the controller 240, which operates to execute logic or computer instructions stored in the memory 242, as well as controlling the components of the base station 1100 that provide the features and functionality of the base station 1100. The base station 1100, under control of the controller 240, transmits and receives signals via wireless radios 1101a-t and the antennas 234a-t. The wireless radios 1101a-t include various components and hardware, as illustrated in FIG. 2 for the base station 105, including the modulator and demodulators 232a-t, the transmit processor 220, the TX MIMO processor 230, the MIMO detector 236, and the receive processor 238.

As shown, the memory 242 may include CLI configuration logic 1102, transmit logic 1103, and receive logic 1104. The CLI configuration logic 1102 may be configured to configure one or more CLI resources for a UE. The transmit logic 1103 may be configured to initiate transmission of messages to the UE, such as messages including CLI resource configurations. The receive logic 1104 may be configured to receive messages from the UE, such as CLI measurement reports. The base station 1100 may receive signals from or transmit signals to one or more UEs, such as the UE 115 of FIGS. 1, 2, or 4, the UE 306, 308, 314, 316 of FIG. 3, or the UE 900 of FIG. 9.

Referring back to FIG. 10, FIG. 10 is a flow diagram of a process 1000 that supports configuring CLI resources to enable CLI measurements on multiple CLI resources according to some aspects. In block 1002, the base station 1100 transmits, to a UE, a message including a CLI resource configuration indicating multiple ports for a plurality of CLI measurements. The message and the CLI resource configuration may include or correspond to the message 470 and the CLI resource configuration 462, respectively. To illustrate, the base station 1100 may execute, under control of the controller 240, the CLI configuration logic 1102 and the transmit logic 1103 stored in the memory 242. The execution environment of the CLI configuration logic 1102 provides the functionality to generate a CLI resource configuration indicating the multiple ports configured for a UE. The execution environment of the transmit logic 1103 provides the functionality to transmit the message including the CLI resource configuration to the UE.

In block 1004, the base station 1100 receives, from the UE, a CLI measurement report based on the plurality of CLI measurements by the UE via the multiple ports. The CLI measurement report may include or correspond to the CLI measurement report. To illustrate, the base station 1100 may execute, under control of the controller 240, the receive logic 1104 stored in the memory 242. The execution environment of the receive logic 1104 provides the functionality to receive the CLI measurement report based on multiple CLI measurements performed by the UE.

In some implementations, the base station may generate the message. Additionally, or alternatively, the multiple ports include multiple SRS resources. The multiple ports may include the same or fewer number of ports of SRS of an aggressor UE. The multiple ports may be configured to be time division multiplexed across multiple slots, multiple symbols, or a combination thereof. In some implementations, the multiple ports have the same time domain configuration as SRS transmissions of from an aggressor UE.

In some implementations, the base station 1100 may determine a pattern for use of the multiple ports by the UE. For example, the pattern may include or correspond to the pattern 414, 464, or indicator 474. The pattern may include a port switching pattern per slot, per symbol, or a combination thereof. For example, the pattern may indicate to use one port per slot, indicates to switch ports each slot, indicates to switch ports each symbol, or a combination thereof. In some implementations, the message includes an indication of the pattern, the pattern is defined by a standard, or a combination thereof.

In some implementations, the base station 1100 generates an indicator to indicate to whether the UE is to combine combining a set of RX measurements received via a set of Rx antenna ports using a precoder or a beam. The indicator may include or correspond to indicator 478. Additionally, or alternatively, the base station 1100 may transmit the indicator to the UE. For example, the base station 1100 may transmit an RRC, a MAC-CE, or DCI that includes the indicator. As another example, the indicator may be included in the message, such as the message 470.

It is noted that one or more blocks (or operations) described with reference to FIGS. 8 and 10 may be combined with one or more blocks (or operations) described with reference to another of the figures. For example, one or more blocks (or operations) of FIG. 8 may be combined with one or more blocks (or operations) of FIG. 10. As another example, one or more blocks associated with FIGS. 8 or 10 may be combined with one or more blocks (or operations) associated with FIGS. 2 or 4-7. Additionally, or alternatively, one or more operations described above with reference to FIGS. 1-11 may be combined with one or more operations described with reference to another of FIGS. 1-11.

In some aspects, techniques for enabling CLI measurements on CLI resources may include additional aspects, such as any single aspect or any combination of aspects described below or in connection with one or more other processes or devices described elsewhere herein. In some aspects, performing CLI measurements on multiple CLI resources may include an apparatus configured to perform one or more cross-link interference (CLI) measurements on each of multiple ports to determine a plurality of measurement values for the plurality of CLI resources. The apparatus may also be configured to transmit a CLI measurement report based on the plurality of measurement values. In some implementations, the apparatus includes a wireless device, such as a UE. In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a first aspect, the multiple ports include multiple SRS resources. In some implementations of the first aspect, each port (of the multiple ports) corresponds to a different resource or the multiple ports correspond to the same resource.

In a second aspect, alone or in combination with the first aspect, the apparatus is further configured to receive, from a base station, a message including a CLI resource configuration indicating the multiple ports.

In a third aspect, alone or in combination with the second aspect, the CLI measurement report is transmitted to the base station.

In a fourth aspect, alone or in combination with one or more of the first through third aspects, the multiple ports include the same or fewer number of ports of sound reference signals from an aggressor UE.

In a fifth aspect, alone or in combination with one or more of the first through fourth aspects, the multiple ports are configured to be time division multiplexed across multiple slots, multiple symbols, or a combination thereof.

In a sixth aspect, alone or in combination with one or more of the first through fifth aspects, to perform the one or more CLI measurements on each of multiple ports, the apparatus is further configured to perform a first set of one or more CLI measurements during a first slot using a first set of one or more ports of the multiple ports.

In a seventh aspect, in combination with the sixth aspect, to perform the one or more CLI measurements on each of the multiple ports the apparatus is further configured to perform a second set of one or more CLI measurements during a second slot using a second set of one or more ports of the multiple ports.

In an eighth aspect, in combination with the seventh aspect, the first set of one or more ports is different from the second set of one or more ports.

In a ninth aspect, alone or in combination with one or more of the sixth through eighth aspects, the apparatus is further configured to perform a third set of one or more CLI measurements during a third slot using the first set of one or more ports.

In a tenth aspect, in combination with the ninth aspect, the apparatus is further configured to perform a fourth set of one or more CLI measurements during a fourth slot using the second set of one or more ports.

In an eleventh aspect, alone or in combination with one or more of the ninth through tenth aspects, the apparatus is further configured to perform a third set of one or more CLI measurements during a third slot using a third set of one or more ports of the multiple ports.

In a twelfth aspect, in combination with the eleventh aspect, the apparatus is further configured to perform a fourth set of one or more CLI measurements during a fourth slot using a fourth set of one or more ports of the multiple ports.

In a thirteenth aspect, alone or in combination with one or more of the sixth through twelfth aspects, each of the first set of one or more ports and the second set of one or more ports includes a single port.

In a fourteenth aspect, alone or in combination with one or more of the sixth through twelfth aspects, the first set of one or more ports is time division multiplexed within the first slot, and the time division multiplexing is symbol-based or CS-based.

In a fifteenth aspect, alone or in combination with one or more of the first through fifth aspects, to perform the one or more CLI measurements on each of multiple ports, the apparatus if further configured to perform a first CLI measurement during a first symbol of a plurality of symbols using a first port of the multiple ports.

In a sixteenth aspect, in combination with the fifteenth aspect, to perform the one or more CLI measurements on each of multiple ports, the apparatus is further configured to perform a second CLI measurement during a second symbol of the plurality of symbols using a second port of the multiple ports.

In a seventeenth aspect, in combination with the sixteenth aspect, the plurality of symbols are included in a single slot, the first symbol and the second symbol are consecutive symbols, the first port and the second port are different ports, or a combination thereof.

In an eighteenth aspect, alone or in combination with one or more of the first through seventeenth aspects, the multiple ports are switched orthogonally by symbol level to perform the one or more CLI measurements.

In a nineteenth aspect, alone or in combination with one or more of the first through eighteenth aspects, the multiple ports have the same time domain configuration as SRS transmissions of from an aggressor UE.

In a twentieth aspect, alone or in combination with one or more of the first through nineteenth aspects, to perform the one or more CLI measurements on each of multiple ports, the apparatus is further configured to select one or more ports for a CLI measurement according to a pattern.

In a twenty-first aspect, in combination with the twentieth aspect, the pattern comprises a port switching pattern per slot, per symbol, or a combination thereof, and optionally, the multiple ports correspond to the same resource.

In a twenty-second aspect, alone or in combination with one or more of the twentieth through twenty-first aspects, the pattern indicates to use one port per slot, indicates to switch ports each slot, indicates to switch ports each symbol, or a combination thereof.

In a twenty-third aspect, alone or in combination with one or more of the twentieth through twenty-second aspects, the message includes an indication of the pattern.

In a twenty-fourth aspect, alone or in combination with one or more of the twentieth through twenty-second aspects, the pattern is defined by a standard.

In a twenty-fifth aspect, alone or in combination with one or more of the twentieth through twenty-fourth aspects, claims 21-23, the apparatus is further configured to determining, by the UE, the pattern.

In a twenty-sixth aspect, alone or in combination with one or more of the first through twenty-fifth aspects, to perform the multiple CLI measurements, the apparatus if further configured to perform a first set of CLI measurements using a first port of the multiple ports and a second port of the multiple ports during the same symbol, and, optionally, the multiple ports correspond to the same resource.

In a twenty-seventh aspect, in combination with the twenty-sixth aspect, the apparatus is further configured to generate the CLI measurement report to indicate a first CLI measurement from the first port and a second CLI measurement from the second port.

In a twenty-eighth aspect, in combination with the twenty-sixth aspect, the apparatus is further configured to combine a first CLI measurement from the first port and a second CLI measurement from the second port to generate a combined CLI measurement, and generate the CLI measurement report to indicate the combined measurement.

In a twenty-ninth aspect, in combination with the twenty-eighth aspect, to combine a first CLI measurement from the first port and a second CLI measurement from the second port, the apparatus is further configured to average the first CLI measurement and the second CLI measurement.

In a thirtieth aspect, in combination with the twenty-eighth aspect, to combine a first CLI measurement from the first port and a second CLI measurement from the second port, the apparatus is further configured to select the maximum of the first CLI measurement and second CLI measurement as the combined measurement.

In a thirty-first aspect, alone or in combination with one or more of the first through thirtieth aspects, the multiple CLI measurements are performed via multiple receive (RX) antenna ports.

In a thirty-second aspect, in combination with the thirty-first aspect, the apparatus is further configured to average measurements received via a set of RX antenna ports of the multiple RX antenna ports.

In a thirty-third aspect, in combination with the thirty-first aspect, the apparatus is further configured to determine a maximum measurement of a set of RX measurements received via a set of RX antenna ports of the multiple RX antenna ports.

In a thirty-fourth aspect, in combination with the thirty-first aspect, the apparatus is further configured to combine a set of RX measurements received via a set of Rx antenna ports of the multiple RX antenna ports using a precoder or a beam.

In a thirty-fifth aspect, in combination with the thirty-fourth aspect, the apparatus is further configured to receive, from a base station, an indicator corresponding to the precoder or the beam.

In a thirty-sixth aspect, in combination with the thirty-fifth aspect, the apparatus is further configured to receive an RRC, a MAC-CE, or DCI that includes the indicator.

In a thirty-seventh aspect, in combination with the thirty-fifth aspect, the apparatus is further configured to receive, from a base station, a message including a CLI resource configuration indicating the multiple ports, and the message includes the indicator.

In a thirty-eighth aspect, alone or in combination with one or more of the first through thirty-seventh aspects, the apparatus is further configured to combine a set of CLI measurements from a set of port of the multiple ports, and combine a set of RX measurements from a set of the RX antenna ports of the multiple RX antenna ports.

In a thirty-ninth aspect, in combination with the thirty-eighth aspect, the set of CLI measurements are combined prior to the set of RX measurements being combined.

In a fortieth aspect, in combination with the thirty-eighth aspect, the set of RX measurements are combined prior to the set of CLI measurements being combined.

In some aspects, an apparatus configured for wireless communication, such as a base station, is configured to transmit, to a user equipment (UE), a message including a cross-link interference (CLI) resource configuration indicating multiple ports for a plurality of CLI measurements. The apparatus is also configured to receive, from the UE, a CLI measurement report based on the plurality of CLI measurements by the UE via the multiple ports. In some implementations, the apparatus includes a wireless device, such as a base station. In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a forty-first aspect, the multiple ports include multiple SRS resources.

In a forty-second aspect, alone or in combination with the forty-first aspect, the apparatus is further configured to generate the message.

In a forty-third aspect, alone or in combination with one or more of the forty-first through forty-second aspects, the multiple ports include the same or fewer number of ports of sound reference signals of an aggressor UE.

In a forty-fourth aspect, alone or in combination with one or more of the forty-first through forty-third aspects, the multiple ports are configured to be time division multiplexed across multiple slots, multiple symbols, or a combination thereof.

In a forty-fifth aspect, alone or in combination with one or more of the forty-first through forty-fourth aspects, the multiple ports have the same time domain configuration as SRS transmissions of from an aggressor UE.

In a forty-sixth aspect, alone or in combination with one or more of the forty-first through forty-fifth aspects, the apparatus is further configured to determine a pattern for use of the multiple ports by the UE.

In a forty-seventh aspect, in combination with the forty-sixth aspect, the pattern includes a port switching pattern per slot, per symbol, or a combination thereof.

In a forty-eighth aspect, alone or in combination with one or more of the forty-sixth through forty-seventh aspects, the pattern indicates to use one port per slot, indicates to switch ports each slot, indicates to switch ports each symbol, or a combination thereof.

In a forty-ninth aspect, alone or in combination with one or more of the forty-sixth through forty-eighth aspects, the message includes an indication of the pattern.

In a fiftieth aspect, alone or in combination with one or more of the forty-sixth through forty-eighth aspects, the pattern is defined by a standard.

In a fifty-first aspect, alone or in combination with one or more of the forty-sixth through fiftieth aspects, the apparatus is further configured to generate an indicator to indicate to whether the UE is to combine a set of RX measurements received via a set of Rx antenna ports using a precoder or a beam, and transmit the indicator to the UE.

In a fifty-second aspect, in combination with fifty-first aspect, the apparatus is further configured to transmit an RRC, a MAC-CE, or DCI that includes the indicator.

In a fifty-third aspect, in combination with the fifty-first aspect, the indicator is included in the message.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
performing one or more cross-link interference (CLI) measurements on each of multiple ports to determine a plurality of measurement values for multiple ports: and
transmitting a CLI measurement report based on the plurality of measurement values.

2. The method of claim 1, further comprising;
receiving, from a base station, a message including a CLI resource configuration indicating the multiple ports; and
and wherein the multiple ports include multiple sounding reference signal (SRS) resources;
wherein the CLI measurement report is transmitted to the base station.

3. The method of claim 1, wherein:
the multiple ports include the same or fewer number of ports of sound reference signals from an aggressor UE; and
the multiple ports are configured to be time division multiplexed across multiple slots, multiple symbols, or a combination thereof.

4. The method of claim 1, wherein;
each of the multiple ports is configured to be assigned to a different transmission slot, or wherein each port corresponds to a different resource: or
a single port or a plurality of ports of the multiple ports is assigned to a one slot; and
the plurality of ports assigned to the one slot have a symbol-based assignment or a cyclic shift (CS)-based assignment.

5. The method of claim 1, wherein:
performing the one or more CLI measurements on each of multiple ports includes:
performing a first CLI measurement during a first symbol of a plurality of symbols using a first port of the multiple ports; and
performing a second CLI measurement during a second symbol of the plurality of symbols using a second port of the multiple ports: and
the plurality of symbols are included in a single slot, the first symbol and the second symbol are consecutive symbols, the first port and the second port are different ports, or a combination thereof.

6. The method of claim 1, wherein:
the multiple ports are switched orthogonally by symbol level to perform the one or more CLI measurements;
multiple ports have the same time domain configuration as sounding reference signals (SRS) transmissions of from an aggressor UE;
performing the one or more CLI measurements on each of the multiple ports includes selecting one or more ports for a CLI measurement according to a pattern that includes a port switching pattern per slot, per symbol, or a combination thereof or
a combination thereof.

7. The method of claim 1, wherein performing the multiple CLI measurements comprises performing a first set of CLI measurements using a first port of the multiple ports and a second port of the multiple ports during the same symbol, and wherein the multiple ports correspond to the same resource.

8. The method of claim 7, further comprising;
generating the CLImeasurement report to indicate a first CLI measurement from the first port and a second CLI measurement from the second port;
combining a first CLI measurement from the first port and a second CLI measurement from the second port to generate a combined CLI measurement, wherein combining the first CLI measurement from the first port and the second CLI measurement from the second port includes:
averaging the first CLI measurement and the second CLI measurement, or
selecting the maximum of the first CLI measurement and second CLI measurement as the combined measurement; and
generating the CLI measurement report to indicate the combined CLI measurement.

9. The method of claim 1, wherein the multiple CLI measurements are performed via multiple receive (RX) antenna ports, and further comprising:
averaging measurements received via a set of RX antenna ports of the multiple RX antenna ports, or
determining a maximum measurement of a set of RX measurements received via a set of RX antenna ports of the multiple RX antenna ports.

10. The method of claim 1, wherein the multiple CLI measurements are performed via multiple receive (RX) antenna ports, and further comprising combining a set of RX measurements received via a set of Rx antenna ports of the multiple RX antenna ports using a precoder or a beam; and
receiving a radio resource control (RRC), a medium access control (MAC)-control element (CE), or downlink control information (DCI) that includes an indicator corresponding to the precoder or the beam; or
receiving, from a base station, a message including a CLI resource configuration indicating the multiple ports, and wherein the message includes an indicator corresponding to the precoder or the beam.

11. The method of claim 1, further comprising:
combining a set of CLI measurements from a set of ports of the multiple ports; and
combining a set of receive (RX) measurements from a set of RX antenna ports of multiple RX antenna ports; and
wherein the set of CLI measurements are combined prior to the set of RX measurements being combined, or the set of RX measurements are combined prior to the set of CLI measurements being combined.

12. A user equipment (UE) comprising:
at least one processor: and
a memory coupled with the at least one processor and storing processor-readable code that, when executed by the at least one processor, is configured to:
perform one or more cross-link interference (CLI) measurements on each of multiple ports to determine a plurality of measurement values for the multiple ports: and
initiate transmission of a CLI measurement report based on the plurality of measurement values.

13. The UE of claim 12, wherein the at least one processor is further configured to:
receive, from a base station, a message including a CLI resource configuration indicating the multiple ports; and wherein
the multiple ports include multiple sounding reference signal (SRS) resources; and
the CLI measurement report is received by the base station.

14. The UE of claim 12, wherein:
the multiple ports include the same or fewer number of ports of sound reference signals from an aggressor UE-., and the multiple ports are configured to be time division multiplexed across multiple slots, multiple symbols, or a combination thereof;
each of the multiple ports is configured to be assigned to a different transmission slot: or
a single port or a plurality of ports of the multiple ports is assigned to a one slot, and the plurality of ports assigned to the one slot have a symbol-based assignment or a cyclic shift (CS)-based assignment.

15. The UE of claim 12, wherein:
the multiple ports include the same or fewer number of ports of sound reference signals from an aggressor UE, and the multiple ports are configured to be time division multiplexed across multiple slots, multiple symbols, or a combination thereof; or
to perform the one or more CLI measurements on each of multiple ports, the at least one processor is further configured to:
perform a first CLI measurement during a first symbol of a plurality of symbols using a first port of the multiple ports;
perform a second CLI measurement during a second symbol of the plurality of symbols using a second port of the multiple ports; and
the plurality of symbols are included in a single slot, the first symbol and the second symbol are consecutive symbols, the first port and the second port are different ports, or a combination thereof.

16. The UE of claim 12, wherein:
the multiple ports are switched orthogonally by symbol level to perform the one or more CLI measurements;
multiple ports have the same time domain configuration as sounding reference signals (SRS) transmissions of from an aggressor UE;
to perform the one or more CLI measurements on each of multiple ports, the at least one processor is further configured to select one or more ports for a CLI measurement according to a pattern that includes a port switching pattern per slot, per symbol, or a combination thereof or
a combination thereof.

17. The UE of claim 12, wherein, to perform the multiple CLI measurements, the at least one processor is further configured to perform a first set of CLI measurements using a first port of the multiple ports and a second port of the multiple ports during the same symbol.

18. The UE of claim 12, wherein:
and the multiple CLI measurements are performed via multiple receive (RX) antenna ports,
the at least one processor is further configured to:
average measurements received via a set of RX antenna ports of the multiple RX antenna ports, or
determine a maximum measurement of a set of RX measurements received via a set of RX antenna ports of the multiple RX antenna ports.

19. The UE of claim 12, wherein:
and the multiple CLI measurements are performed via multiple receive (RX) antenna ports;
the at least one processor is further configured to;
combine a set of RX measurements received via a set of Rx antenna ports of the multiple RX antenna ports using a precoder or a beam; and
receive a radio resource control (RRC), a medium access control (MAC)-control element (CE), or downlink control information (DCI) that includes an indicator corresponding to the precoder or the beam: or
receive, from a base station, a message including a CLI resource configuration indicating the multiple ports, and wherein the message includes an indicator corresponding to the precoder or the beam.

20. The UE of claim 12, wherein the at least one processor is further configured to:
combine a set of CLI measurements from a set of ports of the multiple ports: and
combine a set of RX measurements from a set of RX antenna ports of multiple RX antenna ports; and
wherein the set of CLI measurements are combined prior to the set of RX measurements being combined, or the set of RX measurements are combined prior to the set of CLI measurements being combined.

21. A method of wireless communication performed by a base station, the method comprising:
transmitting, to a user equipment (UE), a message including a cross-link interference (CLI) resource configuration indicating multiple ports for a plurality of CLI measurements; and
receiving, from the UE, a CLI measurement report based on the plurality of CLI measurements by the UE via the multiple ports.

22. The method of claim 21, further comprising generating the message, and wherein the multiple ports include multiple sounding reference signal (SRS) resources.

23. The method of claim 21, wherein:
the multiple ports include the same or fewer number of ports of sound reference signals of an aggressor UE;
the multiple ports are configured to be time division multiplexed across multiple slots, multiple symbols, or a combination thereof,
multiple ports have the same time domain configuration as sounding reference signals (SRS) transmissions of from an aggressor UE; or
a combination thereof.

24. The method of claim 21, further comprising;
determining a pattern for use of the multiple ports by the UE, and wherein the pattern comprises a port switching pattern per slot, per symbol, or a combination thereof; and
the pattern indicates to use one port per slot, indicates to switch ports each slot, indicates to switch ports each symbol, or a combination thereof; or
the message includes an indication of the pattern, and the pattern is defined by a standard.

25. The method of claim 21, further comprising:
generating an indicator to indicate to whether the UE is to combine a set of receive (RX) measurements received via a set of Rx antenna ports using a precoder or a beam; and
transmitting the indicator to the UE; wherein:
transmitting the indicator includes transmitting a radio resource control (RRC), a medium access control (MAC)-control element (CE), or downlink control information (DCI) that includes the indicator; or
the indicator is included in the message.

26. A base station comprising:
at least one processor; and
a memory coupled with the at least one processor and storing processor-readable code that, when executed by the at least one processor, is configured to:
initiate transmission, to a user equipment (UE), a message including a cross-link interference (CLI) resource configuration indicating multiple ports for a plurality of CLI measurements; and
receive, from the UE, a CLI measurement report based on the plurality of CLI measurements by the UE via the multiple ports.

27. The base station of claim 26, wherein the at least one processor is further configured to generate the message, and wherein the plurality multiple ports include multiple sounding reference signal (SRS) resources.

28. The base station of claim 26, wherein:
the multiple ports include the same or fewer number of ports of sound reference signals of an aggressor UE;
the multiple ports are configured to be time division multiplexed across multiple slots, multiple symbols, or a combination thereof:
multiple ports have the same time domain configuration as sounding reference signals (SRS) transmissions of from an aggressor UE; or
a combination therof.

29. The base station of claim 26, wherein the at least one processor is further configured to:
determine a pattern for use of the multiple ports by the UE, and wherein the pattern comprises a port switching pattern per slot, per symbol, or a combination thereof: and wherein:
the pattern indicates to use one port per slot, indicates to switch ports each slot, indicates to switch ports each symbol, or a combination thereof: or
the message includes an indication of the pattern, and the pattern is defined by a standard.

30. The base station claim 26, wherein the at least one processor is further configured to:
an indicator indicate whether the UE is to combine a set of receive (RX) measurements received via a set of Rx antenna ports using a precoder or a beam; and
initiate transmission of the indicator to the UE; and
wherein the indicator is included in a radio resource control (RRC), a medium access control (MAC)-control element (CE), or downlink control information (DCI), or the message.
